(19) United States
(12) Patent Application Publication
(10) Pub. No.: US 2016/0140625 A1
(43) Pub. Date: May 19, 2016

(54) METHOD AND APPARATUS FOR DISTRIBUTING ITEMS USING A SOCIAL GRAPH

(71) Applicant: NOKIA TECHNOLOGIES OY, Espoo (FI)

(72) Inventor: Riku SUOMELA, Espoo (FI)

(21) Appl. No.: 15/007,904

(22) Filed: Jan. 27, 2016

Related U.S. Application Data
(63) Continuation of application No. 12/706,650, filed on Feb. 16, 2010, now abandoned.

(51) Int. Cl. G06Q 30/02; G06Q 30/06

(52) U.S. Cl. CPC G06Q 30/0271; G06Q 30/0631

(57) ABSTRACT

An approach is provided for distributing items via a store. A social graph associated with a user account at a store is retrieved. The social graph depicts relationships between the user account and other user accounts. One or more of the other user accounts are selected. A user account history is retrieved for each of the selected other user accounts. Presentation of one or more items from the retrieved user account histories is caused, at least in part.

### RELATED APPLICATION

This application is a continuation of U.S. patent application Ser. No. 12/706,650, filed Feb. 16, 2010, entitled “METHOD AND APPARATUS FOR DISTRIBUTING ITEMS USING A SOCIAL GRAPH”, which is incorporated herein by reference in its entirety.

### BACKGROUND

Service providers (e.g., wireless, cellular, etc.) and device manufacturers are continually challenged to deliver value and convenience to consumers by, for example, providing compelling network services. One such service involves the distribution of applications, content, and products, using for instance, online stores. Given the volume (which is ever increasing) of these available items, users are easily inundated with too many choices. Various methods are utilized to suggest items to users, such as most popular downloads and rankings. However, these recommendations are impersonal and not tailored to the user.

### SOME EXAMPLE EMBODIMENTS

Therefore, there is a need for an approach for distributing items (e.g., applications and/or digital content).

According to one embodiment, a method comprises retrieving a social graph associated with a user account at a store, the social graph depicting relationships between the user account and other user accounts. The method also comprises selecting one or more of the other user accounts. The method further comprises retrieving a user account history for each of the selected other user accounts. The method further comprises causing, at least in part, presentation of one or more items from the retrieved user account histories.

According to another embodiment, an apparatus comprising at least one processor, and at least one memory including computer program code, the at least one memory and the computer program code configured to, with the at least one processor, cause, at least in part, the apparatus to retrieve a social graph associated with a user account at a store, the social graph depicting relationships between the user account and other user accounts. The apparatus is also caused to select one or more of the other user accounts. The apparatus is further caused to retrieve a user account history for each of the selected other user accounts. The apparatus further causes, at least in part, presentation of one or more items from the retrieved user account histories.

According to another embodiment, a computer-readable storage medium carrying one or more sequences of one or more instructions which, when executed by one or more processors, cause, at least in part, an apparatus to retrieve a social graph associated with a user account at a store, the social graph depicting relationships between the user account and other user accounts. The apparatus is also caused to select one or more of the other user accounts. The apparatus is further caused to retrieve a user account history for each of the selected other user accounts. The apparatus further causes, at least in part, presentation of one or more items from the retrieved user account histories.

According to another embodiment, an apparatus comprises means for retrieving a social graph associated with a user account at a store, the social graph depicting relationships between the user account and other user accounts. The apparatus also comprises means for selecting one or more of the other user accounts. The apparatus further comprises means for retrieving a user account history for each of the selected other user accounts. The apparatus further comprises means for causing, at least in part, presentation of one or more items from the retrieved user account histories.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of distributing items to users, according to one embodiment;

FIG. 2 is a diagram of the components of an item distribution platform, according to one embodiment;

FIG. 3 is a diagram of the components of user equipment, according to one embodiment;

FIG. 4 is a flowchart of a process for recommending items to a user, according to one embodiment;

FIG. 5 is a flowchart of a process for updating item information for recommending items, according to one embodiment;

FIG. 6 is a flowchart of a process for generating item information for recommending items, according to one embodiment;

FIG. 7 is a flowchart of a process for determining social relationships for recommending items, according to one embodiment;

FIGS. 8A-8C are diagrams of user interfaces utilized in the processes of FIGS. 4-7, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for distributing items utilizing a social graph are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

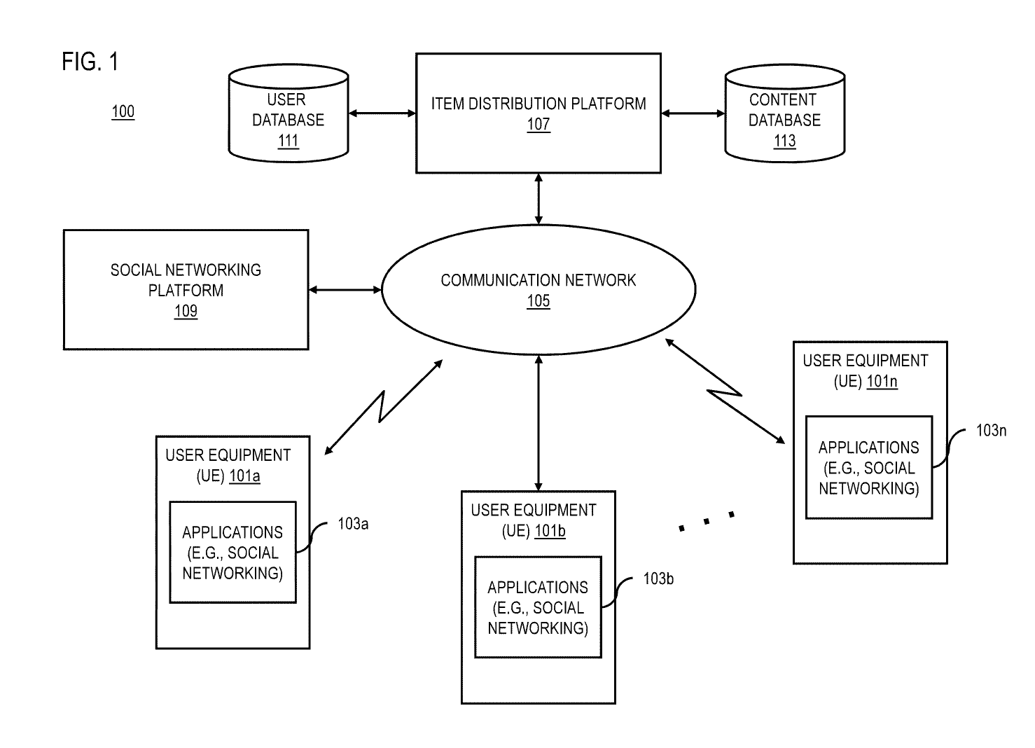

FIG. 1 is a diagram of a system capable of distributing items to users, according to one embodiment. In certain embodiments, the term item refers to physical items such as goods as well as digital items or content such as programs (e.g., applications, utilities, widgets, etc.), media (e.g., pictures, video, audio, wallpapers, themes, games, etc.), etc. that can be executed or presented on user equipment. Although various embodiments are described with respect to an item distribution platform and user equipment, it is contemplated that the approach described herein may be used with other platforms and computing devices. Item distribution platforms such as online stores for goods and/or digital content (e.g., application stores and marketplaces) are utilized to provide content items to users of the platform. As the content available on the platforms become greater, it becomes more difficult for a user to navigate and determine what content the user wishes to acquire.

As mentioned, searching and recommendation methods have not been well-tailored or customized to the user with respect to the user's lifestyle, or the user's equipment and communication services. Rather, the searches and recommendations have been generic and rely on, for example, ratings and use by the user and/or other people unknown to the user. As such, the recommendations tend to reflect the user's previous item acquisitions and acquisitions from other users, who may not possess any preferences that are common to the user. Consequently, these recommendations may not include information about what the user likes (but has not thought about). Further, these items may be niche items that general searches and/or recommendations do not encompass. Thus, there is a need for a more tailored recommendation service for the distribution of content that may be utilized on user equipment. Numerous technical difficulties exist in personalizing recommendations to the user because of the information and processing of information needed to personalize the recommendations to the users. For example, it can be difficult for an online store to acquire social information associated with the user (e.g., determine friends and family of the user) because this type of information is not typically collected by a store. Further, data structures associated with item information and corresponding social information may not be compatible.

To address this problem, a system 100 of FIG. 1 introduces the capability to distribute and recommend items to users in a manner that factor in the user's preferences. As shown, user equipment (UEs) 101a-101n can execute applications 103a-103n (e.g., social networking applications, contacts applications, games, utilities, media players, market application, etc.) and manipulate other digital content (e.g., programs, media, etc.). A user may invoke applications 103 to communicate via a communication network 105 with platforms such as an item distribution platform 107 and/or a social networking platform 109. The UE (e.g., UE 101a or UE 101b) may be connected to the communication network 105 wirelessly or through a wired connection. The item distribution platform 107 (e.g., a digital content store) can be utilized to sell or otherwise distribute digital content as well as other content and items to the user's UE 101. Further, the item distribution platform 107 may be utilized to recommend items for the user. The item distribution platform 107 may collect data about the user as well as other users and store the data in a user database 111. This user data may include information about the user (e.g., user profile information such as a user identifier, name, contact information such as an e-mail address or phone number, description of the user, etc., information about connections to the user (e.g., friends, family, colleagues, contacts, etc.), information about items the user has acquired and/or utilized, or the like). Further, the item distribution platform 107 may include a content database 113 that includes content that may be distributed (e.g., digital content such as applications, media, etc.). To determine recommendations for the user, the item distribution platform 107 can receive and monitor content associated with connections or relationships to the user. These connections may be provided via contact information associated with the user and/or UE 101 as well as via one or more social networking services.

Social networking services may be provided by the social networking platform(s) 109. In certain embodiments, a social networking platform 109 is a platform, such as a computing device, that may be utilized to coordinate and facilitate communications between UEs 101. Examples of social networking platforms 109 include social networking websites and services (e.g., Facebook™, Twitter™, MySpace™ etc.), as well as other computing devices (e.g., a server to coordinate communications between UEs 101). Users may utilize an application 103, such as a social networking application on the user's UEs 101a-101n to access the social networking platform 109. Further, the item distribution platform 107 and the social network platform 109 may include application programming interfaces (APIs) to communicate with each other. As such, user connection information from the social networking platform 109 may be provided to the item distribution platform 107.

Additionally or alternatively, the item distribution platform 107 can retrieve connection information from one or more UEs 101 of the user. Thus, the item distribution platform 107 can provide connection information that may include the relationship status between the user and other users (e.g., via user accounts utilized on one or more social networking platforms 109 and/or contact services). Each of the users may be associated with user identifiers and/or accounts in the user database 111. In certain embodiments, user accounts may be associated with a user identifier, connections to other users (e.g., via contact information), and items that were either acquired by the user via the account or otherwise present on a UE 101 of the user associated with the account. Moreover, a social graph can be generated and stored in the user database 111 to associate the account of one user to the accounts of other users. Further, the social connections in the social graph can be based on contact information associated with one or more accounts (e.g., an e-mail account, a messaging account, etc.) associated with the user. The item distribution platform 107 may have access to these accounts and contact information via an API. In certain embodiments, a social graph is a data structure or a group of data structures (e.g., list, table, etc.) that can store connection and relationship information between users (e.g., connections via accounts of users). For example, groups (e.g., family, friends, colleagues, co-workers, acquaintances, etc.) may be depicted or described within the user accounts. Further, groups associated with a social graph can be automatically organized based on how the user is connected with other users. The connections may additionally be provided values of how reliable, trustworthy, or alike the user is to the other users. For example, the trustworthiness of a user who is a friend on a social networking service may be more trustworthy than a user who is merely a contact (e.g., via an e-mail account). Moreover, privacy rules (e.g., rules for allowing access for certain people to view the user's items) may be implemented based on these relationships. Further, this may be determined by comparing items associated with the user's user account and the items associated with the other users. The user may be rated as more alike to another user if the user and the other user have many of the same items or items in the same categories associated with their user accounts. Alternatively or additionally, contextual information about each user may be utilized to determine likeness (e.g., the location of the users, background, other connections of the users, etc.). A similarity ranking algorithm or pattern recognition techniques may be used to determine the likeness between two users based on what items both have acquired. As such, the item distribution platform 107 and/or its components may be a means for determining similar user accounts based on criteria. Further, the item distribution platform 107 can be a means to cause presentation of the user accounts or information associated with the user accounts (e.g., identifiers, photos, etc.) based on a selection or determination of the user accounts (e.g., based on similarity or other criteria).

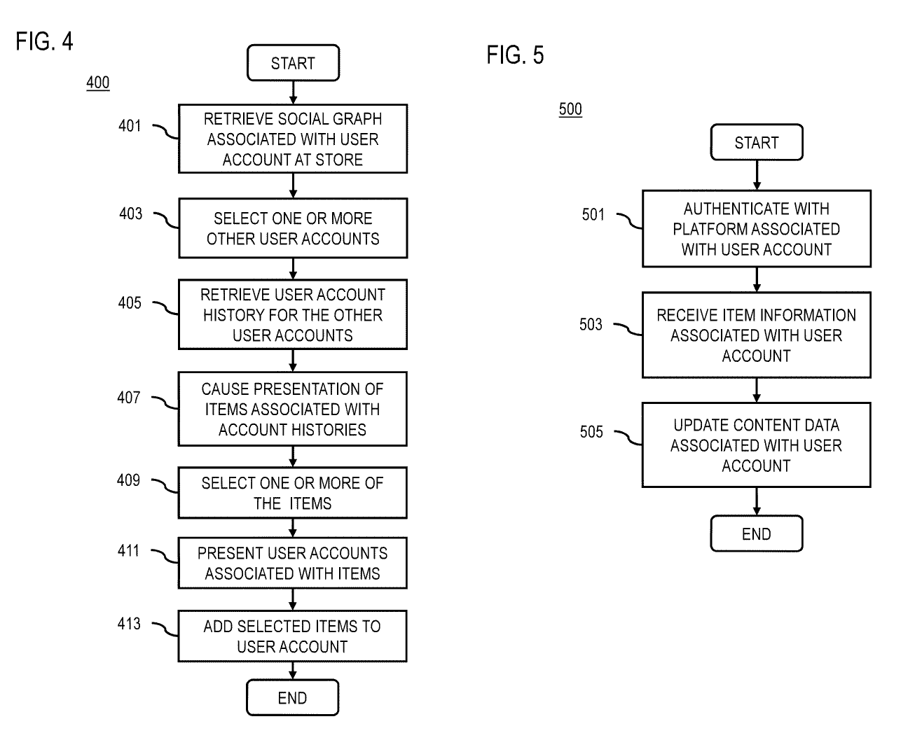

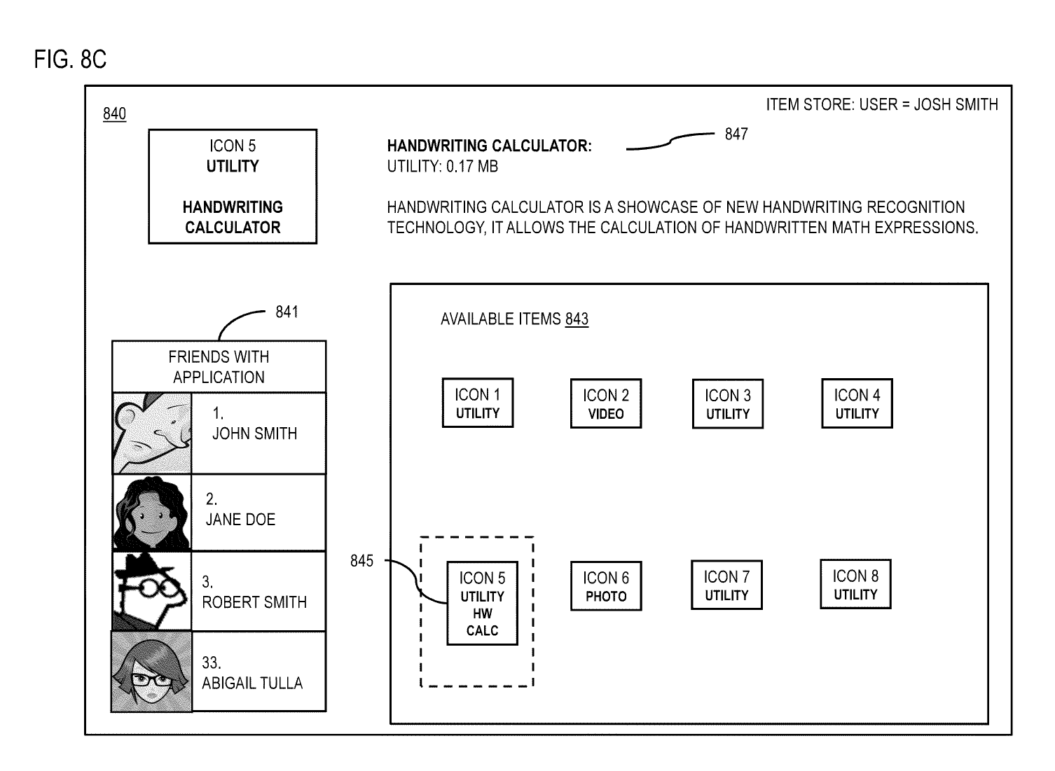

The user can utilize an application 103 to access the item distribution platform 107 to acquire items. During the acquisition process, the UE 101 can present the user with items associated with user accounts connected to the user in a social graph of the user. The item distribution platform 107 or an application 103 on the UE 101 can determine which users to present via processes further detailed in FIGS. 4-7. These other users may be selected by stratifying the other user accounts based on the frequency of communication between the user and the other users, social network distance (e.g., how far away is the connection like is the other person a friend, a friend of a friend, colleague, etc.), context matching or interest profile matching (e.g., via a similarity ranking algorithm), user specification (e.g., via user specified criteria or input selection), or a combination thereof. User accounts more closely related to the user may be selected. As such, one or more of the user accounts may be presented to the user. The user may then select one or more of the user accounts to view a presentation of items associated with the other user accounts. Further, if more than one user accounts are selected, the user may be presented with items that share some commonality between the selected user accounts (e.g., if 5 user accounts are selected, an item may be common if the item (or a variation of the item) is associated with each of the accounts or a threshold number of the accounts (e.g., the item has to be present in at least 3 out of the 5 user accounts)). Further, the presentation of the items may be determined (e.g., sorted or filtered) based on other criteria. Other criteria may include, for example, the frequency of use of the items among the selected other user accounts. Moreover, the presentation of the items to the user's UE 101 may include a graphical representation of desktops of items associated with the other user accounts as further exemplified in FIGS. 8A-8C. Moreover, the user may select one or more of the items presented to view which other user accounts are associated with the items.

Further, in certain embodiments, a user can be encouraged to grant access of the user's item information to the item distribution platform 107 by providing rewards to users partaking in the service. As such, the user can receive reward points (e.g., electronic funds, a credit, etc.) for providing access to the user's item information. Further, when another user purchases an item that was found (e.g., recommended) based on the user's item information, the user can be provided rewards points as a referral fee. If more than one user provides a referral for a purchase, the rewards points may be split (e.g., equally or based on an algorithm). In certain scenarios, the rewards points can be utilized to purchase items from the item distribution platform 107. Additionally or alternatively, a percentage of a sale can be utilized as a basis for the rewards points. Other rewards, such as a discount on the user's next purchase or a coupon, may additionally be offered. Moreover, additional rewards may be provided to a user based on statistics or rankings. For example, additional rewards are provided if the user is ranked high in the number of referrals the user is responsible for during a time period (e.g., a month).

As shown in FIG. 1, the system 100 comprises a user equipment (UE) 101 having connectivity to the item distribution platform and the social networking platform 109 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.).

By way of example, the UE 101, social networking platform 109, and item distribution platform 107 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

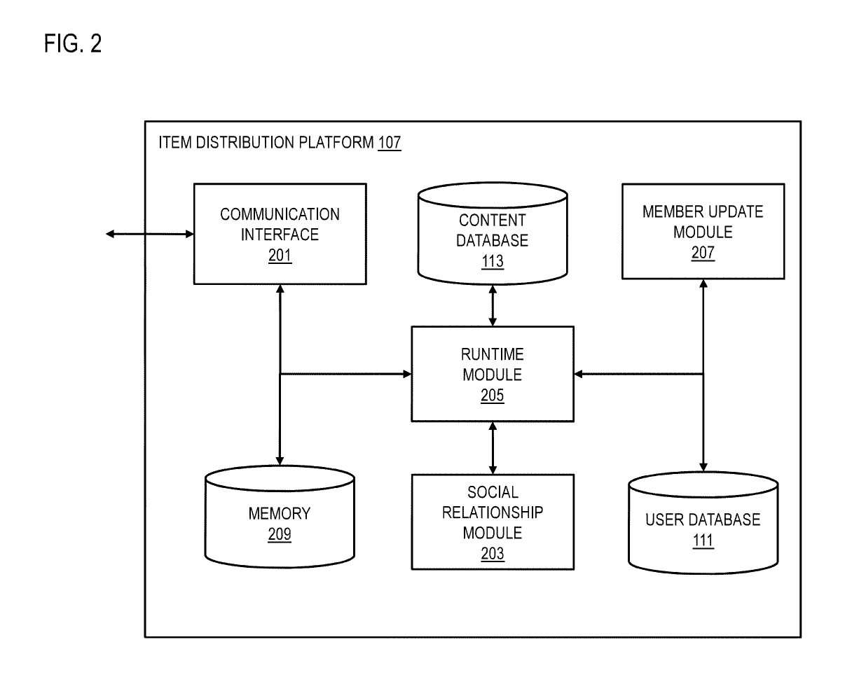

FIG. 2 is a diagram of the components of an item distribution platform, according to one embodiment. By way of example, the item distribution platform 107 includes one or more components for determining and generating a presentation of items to a user of a UE 101. It is contemplated that the functions of these components may be combined in one or more components or performed by other components of equivalent functionality. In this embodiment, the item distribution platform 107 includes a communication interface 201, a social relationship module 203 that can determine relationships between user accounts, a runtime module 205 that can execute processes, a member update module 207 that can be used to update user accounts with information (e.g., information about the amount of times an item has been used by a user associated with a user account), a user database 111, a content database 113 associated with items, and a memory 209.

In one embodiment, the item distribution platform 107 includes the communication interface 201. The communication interface 201 can be used to communicate with a UE 101 and social networking platform 109. The item distribution platform 107 can receive information from the UE 101 and social networking platform 109 via the communication interface 201 via methods such as internet protocol, Multimedia Messaging Service (MMS), Short Message Service (SMS), GPRS, or any other available communication method. The UE 101 can send information to the item distribution platform 107 for many reasons, such as to update the item distribution platform 107 as to the number of times a digital content item has been used by the UE 101.

The social relationship module 203 can be utilized to connect to the social networking platform 109 to retrieve a social graph associated with the user via an API. The social relationship module 203 can receive username and password (or other authentication information) from the user and use the authentication information to access the user's social network. The social relationship module 203 can then modify the social graph to determine relationships between the user and other users. Users may be identified using common identifiers (e.g., a user name, e-mail, a phone number, address, etc.). In this manner, user accounts associated with other users can be matched to user information in the received social graphs from the social networking platform 109. Additionally or alternatively, the user may provide friend contact information and the social relationship module 203 can determine the social graph. In certain scenarios, the social relationship module 203 determines relationships from contact information received from the UE 101 of the user.

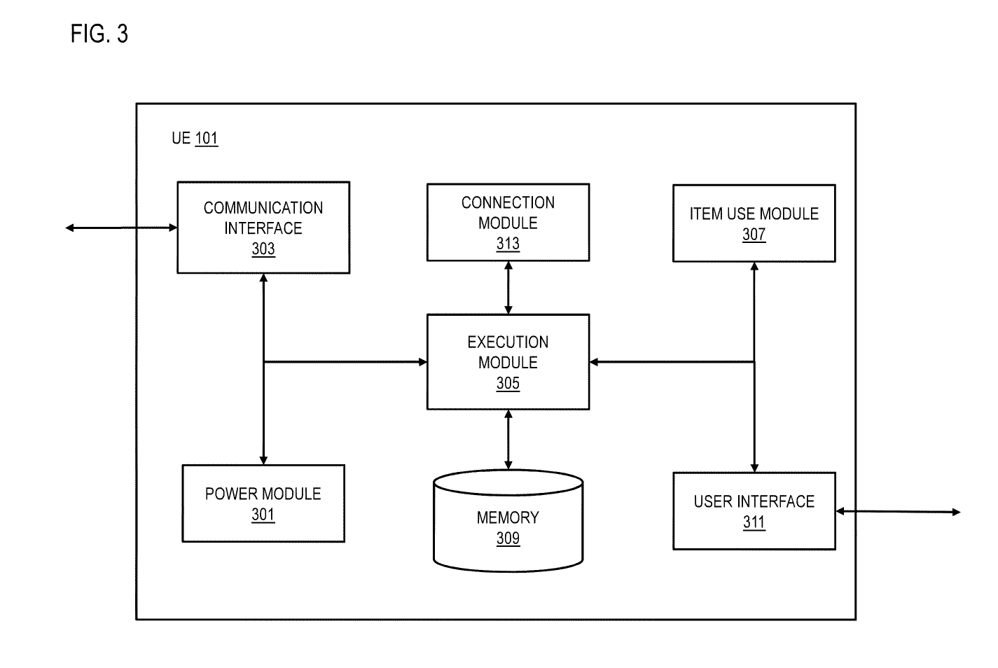

The member update module 207 may receive updates from UEs 101 associated with users to update item information associated with the user as well as user information (e.g., user connection information). In certain embodiments, the member update module 207 connects to the social networking platform 109 via an API to retrieve a social graph associated with the user. In other embodiments, the member update module 207 can receive social graphs and connection information from a UE 101 (e.g., receive contact information and/or a contact history (e.g., call history)). With the connection information, the member update module 207 may update local social graphs associated with the user in the user database 111. Further, the member update module 207 receives item information from the UE 101 via the communication interface 201. The item information can include items that the user has purchased from the item distribution platform 107, other item platforms or stores, or otherwise acquired on the user's UE 101. In certain embodiments, the items are digital content such as applications 103 or media. The item information may additionally include how many times the user has utilized the item. In some embodiments, the items are game applications for the UE 101. In these embodiments, the item information may include game completion information (e.g., a percentage of the game complete, a number of achievements earned (e.g., trophies, certificates, unlocked characters, high score, etc.), etc.). Thus, the item information may include a measure of how much the user likes the item (e.g., more uses or completion, the more the user likes the item). This information may be utilized by the runtime module 205 to determine presentations to provide to the user. The item information may be associated with the user account in the user database 111. Further, member information may be filtered based on privacy features set by the user as further described in FIG. 3.

The communication interface 201 may additionally be utilized to add content to the content database 113. The content database 113 may be populated by the runtime module 205 to include items such as digital content (e.g., applications 103, media, etc.). Further, the content database 113 may include icons, description information, and other information associated with items. This information may be presented to a user when the user is searching for items to purchase or acquire.

When the user searches for items from the item distribution platform 107, the user can request information via the communication interface 201. The runtime module 205 receives the request and associates the user with an account in the user database 111. The runtime module 205 then retrieves a social graph from the user database 111 and determines other users from the social graph to present to the user. The other users may be determined based on various predetermined criteria. Information associated with the other users may be presented to the user on the user's UE 101 as further detailed in FIGS. 8A-8C. The user may then select visual representations of the other users presented via the UE 101. The runtime module 205 receives the input and determines items associated with the selected other users. The items are then presented to the user. The runtime module 205 causes the presentation by initiating transmission of information over the communication interface 201.

FIG. 3 is a diagram of the components of user equipment, according to one embodiment. It is contemplated that the functions of these components may be combined in one or more components or performed by other components of equivalent functionality. In this embodiment, the UE 101 includes a power module 301 to provide power and power controls to the UE 101, a communication interface 303 to communicate over a network, an execution module 305 to control the runtime of applications executing on the UE 101, an item use module 307 for determining use information of items, a memory 309, a user interface 311 to output and receive input at the UE 101, and a connection module 313 to update connection information in the memory.

As noted, the UE 101 includes a power module 301. The power module 301 provides power to the UE 101. The power module 301 can include any type of power source (e.g., battery, plug-in, etc.). Additionally, the power module 301 can provide power to the components of the UE 101 including processors, memory 309, and transmitters.

The communication interface 303 may include multiple means of communication. For example, the communication interface 303 may be able to communicate over SMS, internet protocol, instant messaging, voice sessions (e.g., via a phone network), or other types of communication. The communication interface 303 can be used by the execution module 305 to communicate with other UEs 101, the social networking platform 109, an item distribution platform 107, and other devices. In some examples, the communication interface 303 is used to transmit and receive information to receive recommendations associated with items associated with other users and other user accounts that may be connected to the user.

In one embodiment, a UE 101 includes a user interface 311. The user interface 311 can include various methods of communication. For example, the user interface 311 can have outputs including a visual component (e.g., a screen), an audio component, a physical component (e.g., vibrations), and other methods of communication. User inputs can include a touch-screen interface, a scroll-and-click interface, a button interface, etc. In certain embodiments, the user interface 311 may additionally have a vocal user interface component. As such, a text-to-speech mechanism may be utilized to provide textual information to the user. Further, a speech-to-text mechanism may be utilized to receive vocal input and convert the vocal input into textual input. Moreover, the user interface 311 may be utilized to present information associated with other uses and items associated with other users as further detailed in FIGS. 8A-8C.

In certain embodiments, a store application or an item acquisition application may execute on the execution module 305. Thus, the user may utilize the execution module 305 to connect to an item distribution platform 107 to receive information about items associated with other users. As such, this information may be presented to the user via the user interface 311. Further, the user may interact with the item distribution platform 107 via the user interface 311. The execution module 305 may additionally be utilized to acquire the item. In certain instances, the item includes digital content (e.g., applications, wallpapers, etc.) that can be executed on the execution module 305 and/or presented via the user interface. Once items are acquired, the user may use the items. Item use may be tracked via an item use module 307 that can determine the frequency of use, the number of times used, the completion status of use of an application or game, a combination thereof, or the like. The item use information may be stored in the memory 309. The execution module 305 can be utilized to provide the item use information to the item distribution platform 107 to allow for the user's item information to be accessed in determining items to present to a user.

The connection module 313 can be utilized to determine contacts that the user has. The connection module 313 may additionally determine communications between the user's UE 101 and the contacts. This information may be stored in memory 309. The connection module 313 can be utilized to synchronize contact information with other platforms (e.g., the social networking platform 109, item distribution platform 107, etc.) as well as update information of communications (e.g., phone calls, text messages, instant messages, etc.) between the user and contacts (e.g., the frequency of communications, the recentness of communications, or the like). This information may additionally be utilized by the item distribution platform 107 to determine relationships between the user and contacts (e.g., which contacts are closer in relationship to the user).

As noted above, the item use module 307 can be utilized to determine how well the user likes a particular item that can be utilized by the UE 101. This information may be useful for the item distribution platform 107 for determining the order of items to present to users viewing the user's items. Additionally or alternatively, the item distribution platform 107 utilizes connection information from the connection module 313. As such, privacy settings may be utilized by the UE 101 and/or item distribution platform 107 as to what information can be used by the item distribution platform 107. In this manner, the user is able to select the information gathered by the connection module 313, item use module 307, and other user information that the user wishes to provide to the item distribution platform 107 for recommending items to other users. Thus, the user may utilize privacy features to limit access to other users to view the user's items or use of items to users that are in a certain group (e.g., friends, colleagues, friends of friends, etc.) or to users that are not part of the group. For example, the user can limit access of co-workers to view the user's items. In one example, the user can specify that games associated with the user can only be presented to friends of the user. As such, colleagues and friends of friends may be denied access to view the user's games. Further, the user may select an option to allow colleagues or co-workers access to only the user's business applications. Thus, the user's personal life can be separated from the user's work life. In certain scenarios, the user can set privacy rules so that the allowance of entire application categories (e.g., games, utilities, office applications, video, audio, images, mature applications, rated everyone applications, etc.) can be mapped to users or groups of users. The privacy rules and features set by the user can then be provided to the item distribution platform 107 via the communication interface 303. Further, in certain embodiments, the privacy rules may be set so that the item distribution platform 107 is not provided certain information the user does not wish shared.

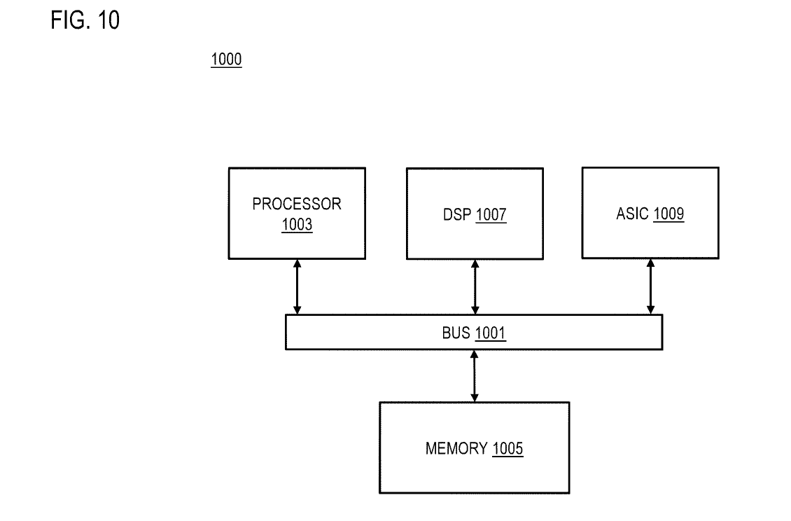

FIG. 4 is a flowchart of a process for recommending items to a user, according to one embodiment. In one embodiment, the runtime module 205 performs the process 400 and is implemented in, for instance, a chip set including a processor and a memory as shown FIG. 10. In certain embodiments, the execution module 305 of a UE 101 may perform one or more steps of the process performed by the runtime module 205. As such, the runtime module 205 or execution module 305 can provide means for accomplishing various parts of the process 400 as well as means for accomplishing other processes in conjunction with other components. The user of the UE 101 can utilize a user interface 311 to acquire items from the item distribution platform 107 (e.g., a store). The runtime module 205 receives a request from the UE 101 for presentation of items.

In step 401, the runtime module 205 retrieves a social graph associated with a user account at the store. The user account can be associated with the store or other platform. In certain embodiments, the store is an online store that sells or otherwise provides goods and/or services. These goods and/or services may include digital content such as applications and/or wallpaper. As such, the social graph can depict relationships between the user account and other user accounts. As noted above, the social graph can be a data structure that stores connection and/or relationship information between users.

The runtime module 205 can then select one or more of the other user accounts (step 403). The selection may be based on predetermined criteria. The runtime module 205 can stratify the other user accounts in relation to the user account based on the predetermined criteria. The predetermined criteria can include a frequency of communication, a social network distance, context matching, interest profile matching, user specification, or a combination thereof. The frequency of communication may be based on communications on the user's UE 101, via a social networking platform 109, or the like. The social distance can be determined based on the social graph. As noted above, context matching and/or interest profile matching can be determined based on information stored in the user account and other user accounts. Further, the user can provide other criteria and may provide input to select other user accounts. In certain embodiments, a quantity (e.g., a predetermined or dynamic quantity) of other user accounts is selected for presentation to the user. Then, the user may select one or more of the other user accounts via input or via other means. Additionally or alternatively, the runtime module 205 can determine the other user accounts selected for presentation (e.g., based on the criteria). Input from the user can be provided via the communication interface 201 from a UE 101.

A user account history for each of the selected other user accounts is retrieved e.g., from a user database 111 (step 405). The user account histories may include items acquired by the respective other user via the store, items present on the other user's UE 101, contextual information about the other user, etc. Then, the runtime module 205 causes, at least in part, presentation of one or more items from the retrieved user account histories (step 407). The runtime module 205 can cause presentation by initiating transmission of information leading to the presentation on a UE 101, initiating transmission of a request for presentation by the UE 101, or the like. The presentation may additionally be based, at least in part, on a commonality of the items among the selected user accounts. If one of the other user accounts is selected, the user account is common to itself If more than one of the other user accounts is selected, the commonality may be based on which items are common to one or more of the selected user accounts based on a set of rules. One rule can include items that are common to at least a certain number of the selected user accounts (e.g., common to at least 2 of the accounts). Another rule can include items that are common to at least a certain percentage or fraction of the selected accounts (e.g., at least a third of the selected accounts). As part of the presentation, the user can view the items as if viewing the desktop of the UEs 101 associated with the other user accounts as shown in FIGS. 8A and 8B. Further, the items may be sorted based on use of the items by the users. For example, the more that the users of the other user accounts use the items (if known), the more prominent the placement of the item.

The runtime module 205 then receives an input for selecting one or more of the items (e.g., via the communication interface 201). This input may be utilized to select one or more of the items (step 409). This selection may be utilized to perform actions using the items as parameters. In certain embodiments, when the item is selected, the runtime module 205 determines which of the other user accounts includes the selected item(s). This can be determined by checking the other users' account histories. In certain embodiments, the other user accounts determined can be any of the accounts associated with the user's social graph. Further, the other user accounts that are associated with the item are presented as shown in FIG. 8C (step 411). In other embodiments, the runtime module 205 may add the selected one or more items to the user's user account (step 413). Moreover, the runtime module 205 can cause transmission of content (e.g., application data, game data, wallpaper data, etc.) associated with the selected item to the user's UE 101. Further, in certain embodiments, the runtime module 205 causes a purchase transaction where the user is charged a fee for the item. Such a fee may be paid via an online transaction method (e.g., credit card, debit, online checking, rewards points, etc.).

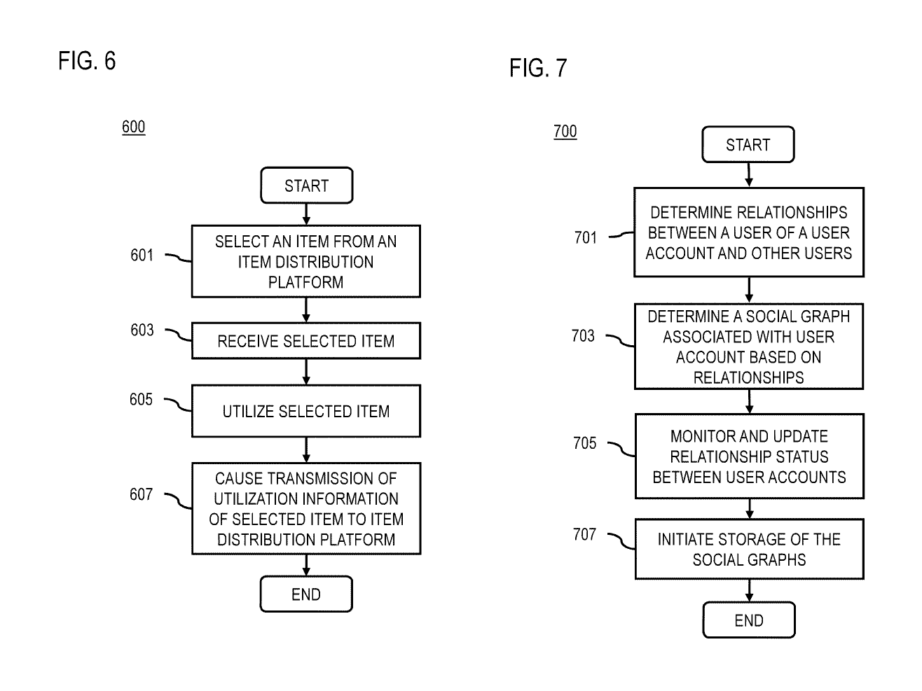

FIG. 5 is a flowchart of a process for updating item information for recommending items, according to one embodiment. In one embodiment, the runtime module 205 performs the process 500 and is implemented in, for instance, a chip set including a processor and a memory as shown FIG. 10. As such, the runtime module 205 can provide means for accomplishing various parts of the process 500 as well as means for accomplishing other processes in conjunction with other components. The user of the UE 101 can utilize a user interface 311 to acquire items from the item distribution platform 107 (e.g., a store).

At step 501, the runtime module 205 authenticates with a UE 101 or other platform associated with a user account of the user. This authentication may occur by receiving a user name and password, token, or other authentication means. Then, the runtime module 205 receives item information associated with the user account (step 503). This may include updated item information of items associated with the UE 101 of the user, such as information about new items on the desktop of the UE 101. Further, the updated item information may include information about the use of the items by the user and/or the user's UE 101 such as the number of times the item was used, the frequency of use, the extent of the use, etc. In certain embodiments, the runtime module 205 can retrieve item information associated with the user of the UE 101 from other platforms such as another item distribution platform 107, a social networking platform 109, or the like. The user may enter authentication information associated with the platforms to allow the runtime module 205 access to an API associated with the respective platforms. As such, the runtime module 205 can have access to other items associated with the user. Further, the runtime module 205 can subscribe to information about the user (e.g., text feeds of a social networking platform 109). The runtime module 205 can then receive and parse the text feeds to determine additional item information. For example, if the feed provides that the user has recently scored a certain record associated with a game, the runtime module 205 ascertains that the user has the game. Further, more than one platform may be searched for additional information about the user.

Then, at step 505, the runtime module 205 updates content data associated with the user account. As such, the account and account history of the account can include the updated item information. Further, the updated item information may be utilized to sort and/or filter items to be presented to the user in process 400. Moreover, as noted above in the discussion of the item use module 307, the use of the user's items may additionally be updated. In the same manner, the user may determine not to share certain item use information or knowledge that certain items belong to the user with particular users. As such, the user can select an option provided by the runtime module 205 that a particular group of users or individual users have access to certain information. Thus, an individual known to the user (e.g., on the user's social graph) can be restricted access to knowledge of the user's items, people belonging to a “co-worker” group associated with the user can be restricted to work-related applications that the user has gathered, etc.

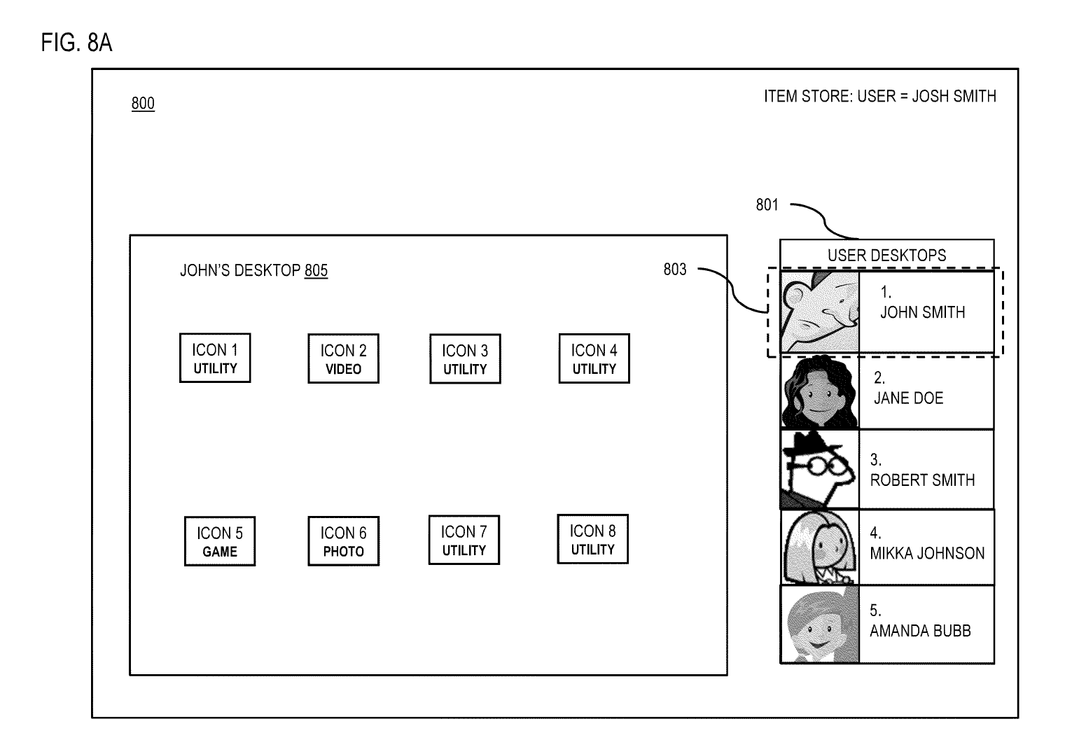

FIG. 6 is a flowchart of a process for generating item information for recommending items, according to one embodiment. In one embodiment, the execution module 305 performs the process 600 and is implemented in, for instance, a chip set including a processor and a memory as shown FIG. 10. As such, execution module 305 can provide means for accomplishing various parts of the process 600 as well as means for accomplishing other processes in conjunction with other components.

The user, via the user's UE 101, can select an item from an item distribution platform 107 (step 601). Further, as noted in process 400, the execution module 305 can receive the selected item (step 603) from the item distribution platform 107. Further, the execution module 305 can utilize the selected item on the UE 101 (step 605). While the UE 101 utilizes the selected item, the UE 101 can collect utilization information about a measure of how much the user likes the selected item. For example, the utilization information may include the completion of use of an application, the frequency of use of the application, the number of times the item was utilized, etc. Then, at step 607, the execution module 305 causes, at least in part, transmission of the utilization information of the selected item to the item distribution platform 107. This information may be utilized in sorting and filtering items for presentation to other users.

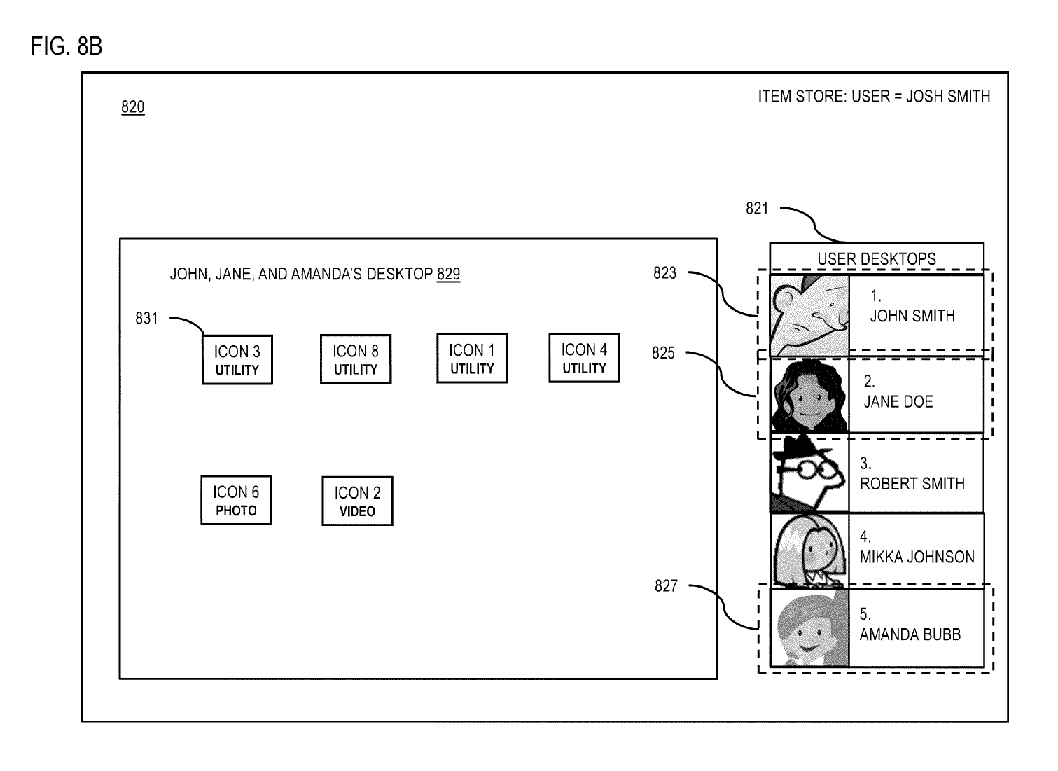

FIG. 7 is a flowchart of a process for determining social relationships for recommending items, according to one embodiment. In one embodiment, the runtime module 205 performs the process 700 and is implemented in, for instance, a chip set including a processor and a memory as shown FIG. 10. As such, the runtime module 205 can provide means for accomplishing various parts of the process 700 as well as means for accomplishing other processes in conjunction with other components.

At step 701, the runtime module 205 determines relationships between a user of a user account and other users. In certain embodiments, the runtime module 205 can utilize a social relationship module 203 to receive relationship information about the user, including acquiring predetermined social graphs. In other embodiments, the runtime module 205 determines a social graph associated with the user account based on the determined relationships (step 703). The relationships may be acquired from the user's UE 101, which can have contact and connection information including identifiers (e.g., a user name, e-mail, a phone number, address, etc.) associated with connections of the user as well as the frequency of contact with the connections. The frequency of contact or a number of contacts may be utilized to group the connections. Further, the runtime module 205 monitors and updates the relationship status between user accounts (step 705). For example, the runtime module 205 can receive information about the user's recent connections and utilize that information to update the relationship status between user accounts (e.g., the user's relationship with another user can be determined to be good friends one month due to a lot of contact to an acquaintance status in another month due to little or no contact during another month). Once a social graph is complete and updated, the runtime module 205 initiates, as in step 707, storage of the social graph in a user database 111 associated with the user's account.

FIGS. 8A-8C are diagrams of user interfaces utilized in the processes of FIGS. 4-7, according to various embodiments. User interface 800 provides section 801 of the user interface 800 that can show connections of the user that may be utilized to present items that the user may want to acquire. As previously detailed in FIG. 4, the users presented in the section 801 can be determined from a social graph based on criteria. Then, the user can select one of the users, e.g., John Smith 803. When John Smith 803 is selected, UE 101 can receive information associated with a desktop 805 associated with John Smith 803. The desktop 805 includes items that John Smith has associated with his user account (e.g., via acquiring the items from the item distribution platform 107 or on a desktop of John Smith's UE). The desktop 805 may be sorted based on rules (e.g., rules selected by the user). As such, the presentation of the items can be a graphical representation of John Smith's desktop 805. Thus, the presentation of the items may be modified by the sorting rules (e.g., most recently used by John Smith, most frequently used by John Smith, etc.).

User interface 820 of FIG. 8B provides a section 821 of the user interface 820 that can show connections of the user that may be utilized to present items that the user may want to acquire. The user can select a set of the users 823, 825, 827. When the users 823, 825, 827 are selected, UE 101 can receive information associated with a desktop 829 associated with the users 823, 825, 827. The desktop 829 includes items that are common to the users 823, 825, 827. For example, a Utility 831 can be an item common to all three of the selected users 823, 825, 827, or common to a certain amount of the users 823, 825, 827 (e.g., 1 user, 2 users, 3 users, etc.). The desktop 829 can be sorted as mentioned in FIG. 4.

The user interface 840 of FIG. 8C provides a section 841 of the user interface 840 that can show connections of the user. The user may select items from an available items menu 843 to determine which connections are associated with the items (e.g., have acquired the item, use the item, etc.). In this example, the user selects a handwriting calculator application 845. A description of the handwriting calculator may be displayed in another section 847. When the handwriting calculator application 845 is selected, the UE 101 can cause transmission of the selection to the item distribution platform 107 (e.g., the item store) and provide the selection to the item distribution platform 107. Then, user interface 840 can present the section 841 of connections (e.g., friends, co-workers, acquaintances, etc.) that have the handwriting calculator application 845 associated with their accounts.

With the above approaches, the user is provided recommendations to purchase items based on the social experiences of other users. As such, the item distribution platform 107 can advantageously customize the presentation of items the user may wish to acquire (e.g., purchase, download for free, etc.). Because the presentation is customized for the user, the UE 101 of the user uses less bandwidth because less information is needed to be transferred from the item distribution platform 107 to the UE 101 because the presentation is customized to the user. Further, because the presentation is tailored to the user, the processing time of the UE 101 to provide item selection to the user is reduced. This saves energy and reduces processing time for the UE 101.

The processes described herein for providing distribution of items to users may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

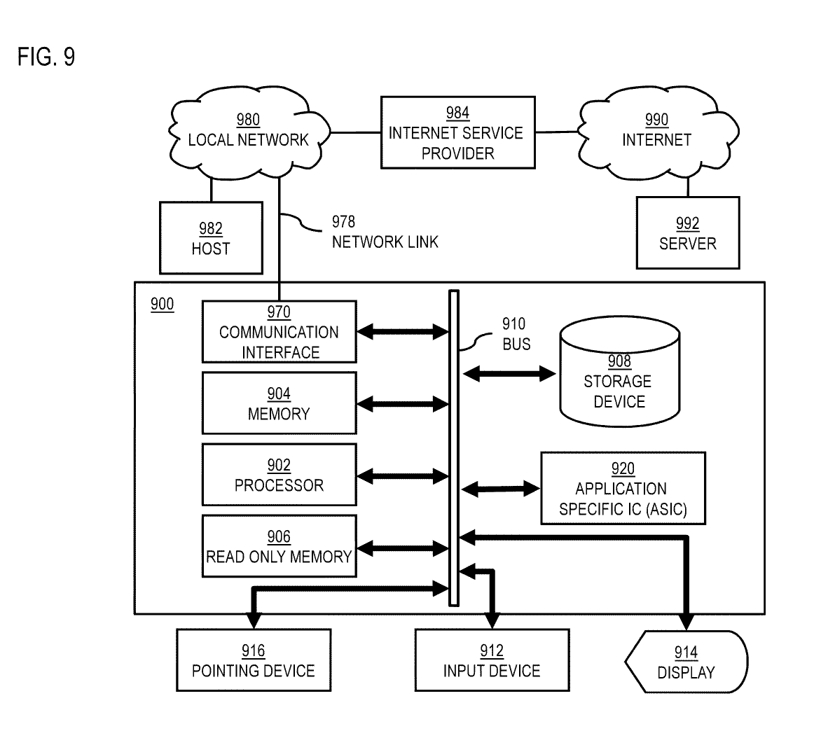

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to distribute of items to users as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of distributing of items to users.

A bus 910 includes one or more parallel conductors of information so that information is transferred quickly among devices coupled to the bus 910. One or more processors 902 for processing information are coupled with the bus 910.

A processor 902 performs a set of operations on information as specified by computer program code related to the distribution of items to users. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or other dynamic storage device, stores information including processor instructions for distributing items to users. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for distributing items to users, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, which carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for the UE 101.

The term “computer-readable medium” as used herein to refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set 1000 upon which an embodiment of the invention may be implemented. Chip set 1000 is programmed to distribute items to users as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1000, or a portion thereof, constitutes a means for performing one or more steps of distributing items to users.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to distribute items to users. The memory 1005 also stores the data associated with or generated by the execution of the inventive steps.

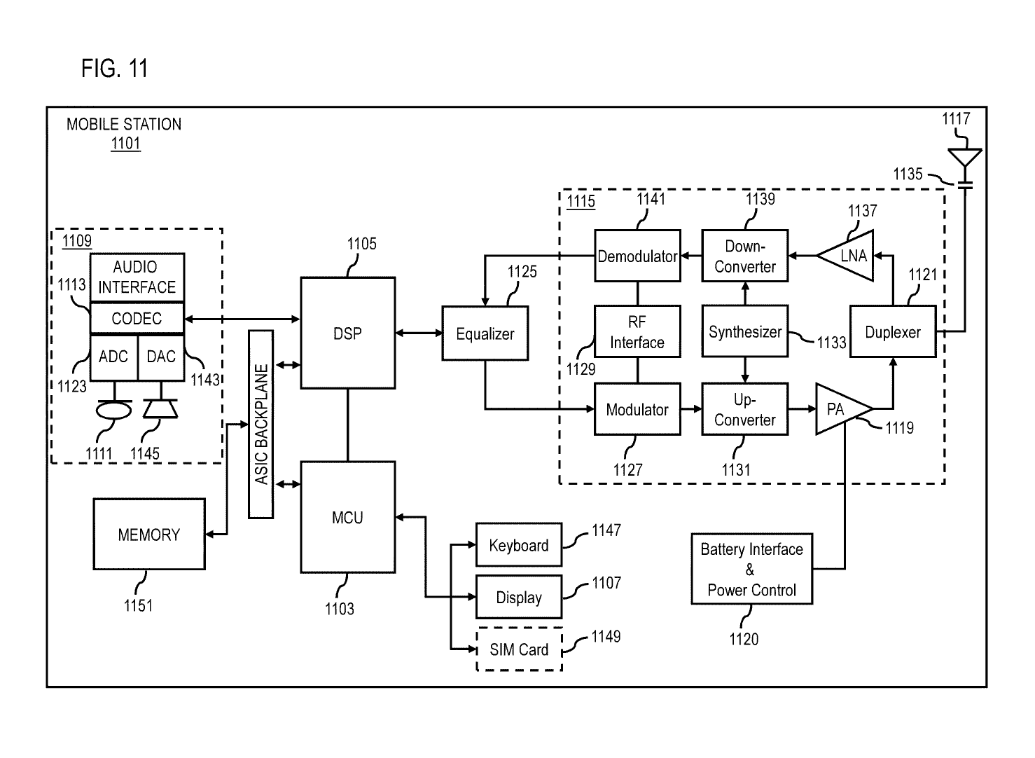

FIG. 11 is a diagram of exemplary components of a mobile terminal (e.g., handset) for communications, which is capable of operating in the system of FIG. 1, according to one embodiment. In some embodiments, mobile terminal 1100, or a portion thereof, constitutes a means for performing one or more steps of distributing items to users. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of distributing items to users. The display 11 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to distribute items to users. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
retrieving a plurality of relationship connection information, via an application programming interface (API) associated with at least one social networking platform, of a user account at a store with other user accounts;
generating a social graph associated with the user account, the social graph depicting relationships between the user account and the other user accounts based on the plurality of relationship connection information and additional information from additional user accounts associated with the user account,
wherein the additional user accounts include e-mail accounts, messaging accounts, or a combination thereof, and wherein the social graph is stored and maintained within a user database maintained by an item distribution platform;
selecting a plurality of the other user accounts from the user database;
retrieving a user account history for each of the selected other user accounts; and
causing, at least in part, presentation of one or more items from the retrieved user account histories based at least in part on a sorting or filtering of the items among the selected other user accounts.

2. A method of claim 1, further comprising:
receiving an input for selecting one or more of the items; and
adding the selected one or more items to the user account.

3. A method of claim 1, further comprising:
stratifying the other user accounts by predetermined criteria,
wherein the selecting of the other user accounts is based at least in part on the stratification.

4. A method of claim 3, wherein the predetermined criteria includes a frequency of communication, a social network distance, a context matching, an interest profile matching, a user specification, or a combination thereof.

5. A method of claim 1, further comprising:
receiving an input for selecting one or more of the items;
determining, via the at least one processor, which of the other user accounts includes the selected one or more items; and
causing, at least in part, via the at least one processor, presentation of the determined other user accounts.

6. A method of claim 1, wherein the presentation of the one or more items is based at least in part on a commonality of the items among the selected other user accounts.

7. A method of claim 1, wherein the presentation of the one or more items is based at least in part on a frequency of use of the items among the selected other user accounts.

8. A method of claim 1, wherein the presentation of the one or more items is a graphical representation of the respective desktops of the selected other user accounts.

9. An apparatus comprising:
at least one processor; and
at least one memory including computer program code,
the at least one memory and the computer program code configured to, with the at least one processor, cause the apparatus to perform at least the following,
retrieve a plurality of relationship connection information, via an application programming interface (API) associated with at least one social networking platform, of a user account at a store with other user accounts;
generate a social graph associated with the user account, the social graph depicting relationships between the user account and the other user accounts based on the plurality of relationship connection information and additional information from additional user accounts associated with the user account,
wherein the additional user accounts include e-mail accounts, messaging accounts, or a combination thereof, and wherein the social graph is stored and maintained within a user database maintained by an item distribution platform;
select a plurality of the other user accounts from the user database;
retrieve a user account history for each of the selected other user accounts; and
cause, at least in part, presentation of one or more items from the retrieved user account histories based at least in part on a sorting or filtering of the items among the selected other user accounts.

10. An apparatus of claim 9, wherein the apparatus is further caused, at least in part, to:
receive an input for selecting one or more of the items; and
add the selected one or more items to the user account.

11. An apparatus of claim 9, wherein the apparatus is further caused, at least in part, to:
stratify the other user accounts by predetermined criteria,
wherein the selecting of the other user accounts is based at least in part on the stratification.

12. An apparatus of claim 11, wherein the predetermined criteria includes a frequency of communication, a social network distance, a context matching, an interest profile matching, a user specification, or a combination thereof.

13. An apparatus of claim 9, wherein the apparatus is further caused, at least in part, to:
receive an input for selecting one or more of the items;
determine which of the other user accounts includes the selected one or more items; and
cause, at least in part, presentation of the determined other user accounts.

14. An apparatus of claim 9, wherein the presentation of the one or more items is based at least in part on a commonality of the items among the selected other user accounts.

15. An apparatus of claim 9, wherein the presentation of the one or more items is based at least in part on a frequency of use of the items among the selected other user accounts.

16. An apparatus of claim 9, wherein the presentation of the one or more items is a graphical representation of the respective desktops of the selected other user accounts.

17. A computer-readable storage medium carrying one or more sequences of one or more instructions which, when executed by one or more processors, cause an apparatus to at least perform the following steps:
retrieving a plurality of relationship connection information, via an application programming interface (API) associated with at least one social networking platform, of a user account at a store with other user accounts;
generating a social graph associated with the user account, the social graph depicting relationships between the user account and the other user accounts based on the plurality of relationship connection information and additional information from additional user accounts associated with the user account,
wherein the additional user accounts include e-mail accounts, messaging accounts, or a combination thereof, and wherein the social graph is stored and maintained within a user database maintained by an item distribution platform;
selecting a plurality of the other user accounts from the user database;
retrieving a user account history for each of the selected other user accounts; and
causing, at least in part, presentation of one or more items from the retrieved user account histories based at least in part on a sorting or filtering of the items among the selected other user accounts.

18. A computer-readable storage medium of claim 17, wherein the apparatus is caused, at least in part, to further perform:
receiving an input for selecting one or more of the items; and
adding the selected one or more items to the user account.

19. A computer-readable storage medium of claim 17, wherein the apparatus is caused, at least in part, to further perform:
stratifying the other user accounts by predetermined criteria,
wherein the selecting of the other user accounts is based at least in part on the stratification.

20. A computer-readable storage medium of claim 19, wherein the predetermined criteria includes a frequency of communication, a social network distance, a context matching, an interest profile matching, a user specification, or a combination thereof.
